(19) United States
(12) Patent Application Publication
(10) Pub. No.: US 2011/0315859 A1
(43) Pub. Date: Dec. 29, 2011

(54) DISPLAY DEVICE

(76) Inventor: Kohei Tanaka, Osaka (JP)

(21) Appl. No.: 13/254,417

(22) PCT Filed: Oct. 21, 2009
(86) PCT No.: PCT/JP2009/068118

§ 371 Date: Sep. 1, 2011

(30) Foreign Application Priority Data
Mar. 2, 2009 (JP) 2009-048399

(51) Int. Cl. H01J 40/14

(52) U.S. Cl. 250/214 R

(57) ABSTRACT

A display device includes a photosensor in a pixel region (1) of an active matrix substrate (100). The photosensor includes a photodiode (D1), a photodiode (D2) as a reference element connected in series to the photodiode (D1) and having a light shielding layer that blocks incident light, a storage capacitor (C_{INT}), one electrode of which is connected to a connection point between the photodiodes (D1, D2), that stores output current from the photodiodes (D1, D2), reset signal wiring (RST) that supplies a reset signal to the photosensor, readout signal wiring (RWS) that supplies a readout signal to the photosensor, and a thin-film transistor (M2) having a control electrode connected to a connection point between the photodiodes (D1, D2). A capacitor (C_{ref}) is provided between the cathode of the photodiode (D2) and the readout signal wiring (RWS).

### TECHNICAL FIELD

The present invention relates to a display device with a photosensor having a photodetection element such as a photodiode, and in particular to a display device that includes a photosensor inside a pixel region.

### BACKGROUND ART

Conventionally, there has been proposed a display device with a photosensor that includes a photodetection element such as a photodiode inside a pixel to measure the brightness of external light and pick up an image of an object that is located close to the display. Such a display device with a photosensor is envisioned to be used as a bidirectional communication display device or display device with a touch panel function.

In a conventional display device with a photosensor, when using a semiconductor process to form known constituent elements such as signal lines, scan lines, TFTs (Thin Film Transistors), and pixel electrodes on an active matrix substrate, a photodiode or the like is simultaneously formed on the active matrix substrate (see PTL 1 and NPL 1).

It is known that sensor output in a display device with a photosensor is largely dependent on environmental temperature. Specifically, there is the problem that when the environmental temperature changes, the characteristics of the photodetection element fluctuate, and a change in light intensity can no longer be properly detected.

Such temperature dependency of a photosensor is attributed to dark current (also called “leakage current”). To compensate for this dark current, a configuration is known in which besides a photosensor having a photodetection element (element for photodetection) that measures the intensity of incident light, a light-shielded photodetection element (reference element) for detecting only dark current is provided as a so-called dummy sensor on an active matrix substrate (see PTL 2 and 3 and NPL 2). In this conventional configuration, since output from the reference element reflects the dark current component, the output from the reference element counteracts with the output from the photodetection element in a downstream circuit of the photosensor, thus enabling obtaining sensor output having reduced temperature dependency.

### Citation List

### Patent Literature

PTL 1: JP 2006-3857A

PTL 2: JP 2007-18458A

PTL 3: JP 2007-81870A

### Non Patent Literature

NPL 1: “A Touch Panel Function Integrated LCD Including LTPS A/D Converter”, T. Nakamura et al., SID 05 DIGEST, pp. 1,054-1,055, 2005

NPL 2: “LTPS Ambient Light Sensor with Temperature Compensation”, S. Koide et al., IDW '06, pp. 689-690, 2006

### DISCLOSURE OF INVENTION

### Problem to be Solved by the Invention

However, in the case where a photodetection element and a reference element are disposed in a pixel region, the storage capacitor of the photodetection element is charged with and discharges both current generated due to incident light and dark current. Accordingly, there is the issue that when the fact that dark current increases at high temperatures is taken into consideration, a wide dynamic range cannot be obtained for the photosensor.

The present invention has been achieved in light of the above-described issues, and an object thereof is to provide a display device having a photosensor with a wide dynamic range and reduced temperature dependency even in the case where a photodetection element and a reference element are disposed in a pixel region.

### Means for Solving Problem

In order to address the above-described issues, a display device according to the present invention is a display device including a photosensor in a pixel region of an active matrix substrate, the photosensor including; a photodetection element that receives incident light; a reference element connected in series to the photodetection element and having a light shielding layer that blocks incident light; a storage capacitor, one electrode of which is connected to a connection point between the photodetection element and the reference element, that is charged with and discharges output current from the photodetection element and the reference element; reset signal wiring that supplies a reset signal to the photosensor; readout signal wiring that supplies a readout signal to the photosensor; a switching element having a control electrode connected to a connection point between the photodetection element and the reference element; and a capacitor connected between the readout signal wiring and an electrode of the reference element that is not connected to the photodetection element, wherein from when the reset signal is supplied until when the readout signal is supplied, the photosensor charges the storage capacitor or outputs sensor output that is in accordance with the output current discharged from the storage capacitor.

### Effects of the Invention

The present invention enables providing a display device having a photosensor with a wide dynamic range and reduced temperature dependency.

### BRIEF DESCRIPTION OF DRAWINGS

FIG. 1 is a block diagram showing a schematic configuration of a display device according to an embodiment of the present invention.

FIG. 2 is an equivalent circuit diagram showing a configuration of a pixel in a display device according to Embodiment 1 of the present invention.

FIG. 3 is a timing chart showing the waveforms of a reset signal supplied from reset signal wiring RST to a photosensor and a readout signal supplied from readout signal wiring RWS in the display device according to Embodiment 1 of the present invention.

FIG. 4 is a waveform diagram showing a relationship between input signals (reset signal and readout signal) and V_{INT} in the photosensor according to Embodiment 1.

FIG. 5 is a timing chart showing sensor drive timing in the display device according to Embodiment 1.

FIG. 6 is a circuit diagram showing an internal configuration of a sensor pixel readout circuit.

FIG. 7 is a waveform diagram showing a relationship between a readout signal, sensor output, and output of the sensor pixel readout circuit.

FIG. 8 is a circuit diagram showing an exemplary configuration of a sensor column amplifier.

FIG. 9 is an equivalent circuit diagram showing a configuration of a pixel in a display device according to Embodiment 2 of the present invention.

FIG. 10 is a timing chart showing the waveforms of a reset signal supplied from reset signal wiring RST to a photosensor and a readout signal supplied from readout signal wiring RWS in the display device according to Embodiment 2 of the present invention.

FIG. 11 is a waveform diagram showing a relationship between input signals (reset signal and readout signal) and V_{INT} in the photosensor according to Embodiment 2.

FIG. 12 is an equivalent circuit diagram showing a configuration of a pixel in a display device according to Embodiment 3 of the present invention.

FIG. 13 is an equivalent circuit diagram showing an example of a variation of the display device according to Embodiment 1.

FIG. 14 is an equivalent circuit diagram showing an example of a variation of the display device according to Embodiment 1.

FIG. 15 is an equivalent circuit diagram showing an example of a variation of the display device according to Embodiment 1.

### DESCRIPTION OF THE INVENTION

A display device according to an embodiment of the present invention is a display device including a photosensor in a pixel region of an active matrix substrate, the photosensor including: a photodetection element that receives incident light; a reference element connected in series to the photodetection element and having a light shielding layer that blocks incident light; a storage capacitor, one electrode of which is connected to a connection point between the photodetection element and the reference element, that is charged with and discharges output current from the photodetection element and the reference element; reset signal wiring that supplies a reset signal to the photosensor; readout signal wiring that supplies a readout signal to the photosensor; a switching element having a control electrode connected to a connection point between the photodetection element and the reference element; and a capacitor connected between the readout signal wiring and an electrode of the reference element that is not connected to the photodetection element, wherein from when the reset signal is supplied until when the readout signal is supplied, the photosensor charges the storage capacitor or outputs sensor output that is in accordance with the output current discharged from the storage capacitor (first configuration).

In this first configuration, one of the electrodes of the storage capacitor that is charged with and discharges output current from the photodetection element and the reference element is connected to a connection point between the photodetection element and the reference element. Also, the control electrode of the switching element for charging the storage capacitor or reading out output current discharged from the storage capacitor from when the reset signal is supplied to when the readout signal is supplied (so-called integration period) is connected to this connection point. Accordingly, in the readout period, the storage capacitor is charged with and discharges the sum of the sum of the photocurrent and the dark current output from the photodetection element (I_{PHOTO}+I_{DARK}), and the dark current (I_{DARK}, having the reversed sign of the dark current I_{DARK} from the photodetection element) output from the reference element. As a result, the storage capacitor is charged with and discharges only the photocurrent I_{PHOTO} component, thus enabling accurately measuring the intensity of external light regardless of the magnitude of the dark current I_{DARK}. Also, a wide dynamic range can be obtained since the storage capacitor neither is charged with nor discharges the dark current I_{DARK}. Accordingly, it is possible to realize a display device including a photosensor that can highly accurately measure the intensity of external light without being influenced by the environmental temperature.

A display device according to an embodiment of the present invention is a display device including a photosensor in a pixel region of an active matrix substrate, the photosensor including: a photodetection element that receives incident light; a reference element connected in series to the photodetection element and having a light shielding layer that blocks incident light; a storage capacitor, one electrode of which is connected to a connection point between the photodetection element and the reference element, that is charged with and discharges output current from the photodetection element and the reference element; reset signal wiring that supplies a reset signal to the photosensor; readout signal wiring that supplies a readout signal to the photosensor; and a switching element having a control electrode connected to a connection point between the photodetection element and the reference element, wherein an electrode of the reference element that is not connected to the photodetection element is connected to the readout signal wiring, and from when the reset signal is supplied until when the readout signal is supplied, the photosensor charges the storage capacitor or outputs sensor output that is in accordance with the output current discharged from the storage capacitor (second configuration).

In this second configuration as well, one of the electrodes of the storage capacitor that is charged with and discharges output current from the photodetection element and the reference element is connected to a connection point between the photodetection element and the reference element. Also, the control electrode of the switching element for charging the storage capacitor or reading out output current discharged from the storage capacitor from when the reset signal is supplied until when the readout signal is supplied (so-called integration period) is connected to this connection point. Accordingly, in the readout period, the storage capacitor is charged with and discharges the sum of the sum of the photocurrent and the dark current output from the photodetection element (I_{PHOTO}+I_{DARK}), and the dark current (I_{DARK}, having the reversed sign of the dark current I_{DARK} from the photodetection element) output from the reference element. As a result, the storage capacitor is charged with and discharges only the photocurrent I_{PHOTO} component, thus enabling accurately measuring the intensity of external light regardless of the magnitude of the dark current I_{DARK}. Also, a wide dynamic range can be obtained since the storage capacitor neither is charged with nor discharges the dark current I_{DARK}. Accordingly, it is possible to realize a display device including a photosensor that can highly accurately measure the intensity of external light without being influenced by the environmental temperature.

The display device according to the first and second configurations can have a configuration in which the switching element is composed of one transistor, and the readout signal wiring is connected to another electrode of the storage capacitor. Alternatively, a configuration is possible in which the switching element is composed of a first transistor and a second transistor, a control electrode of the first transistor is connected to a connection point between the photodetection element and the reference element, one of two electrodes other than the control electrode of the first transistor is connected to wiring that supplies a power supply voltage, the other of the two electrodes other than the control electrode of the first transistor is connected to one of two electrodes other than a control electrode of the second transistor, the readout signal wiring is connected to the control electrode of the second transistor, one electrode of the storage capacitor is connected to the wiring that supplies the power supply voltage, and the other of the two electrodes other than the control electrode of the second transistor is connected to wiring for reading out the output current.

Alternatively, the display device according to the first and second configurations may have a configuration in which the switching element is composed of a first transistor, a second transistor, and a third transistor, a control electrode of the first transistor is connected to a connection point between the photodetection element and the reference element, one of two electrodes other than the control electrode of the first transistor is connected to wiring that supplies a power supply voltage, the other of the two electrodes other than the control electrode of the first transistor is connected to one of two electrodes other than a control electrode of the second transistor, the storage capacitor is connected in parallel to the photodetection element, the readout signal wiring is connected to the control electrode of the second transistor, the other of the two electrodes other than the control electrode of the second transistor is connected to wiring for reading out the output current, a control electrode of the third transistor is connected to the reset signal wiring, one of two electrodes other than the control electrode of the third transistor is connected to a connection point between the photodetection element and the reference element, and the other of the two electrodes other than the control electrode of the third transistor is connected to the wiring that supplies the power supply voltage.

Note that in the display device according to the first and second configurations, it is preferable that in a case where no light is incident on the photosensor, an output current from the photodetection element and an output current from the reference element are equivalent. This is because if the dark current of the photodetection element and the dark current of the reference element are equivalent, temperature dependency can be substantially reliably eliminated when the environmental temperature has changed.

Also, in the display device according to the first and second configurations, it is preferable that the photodetection element and the reference element are each a photodiode, and the length and width of a gap between a p layer and an n layer are substantially equivalent between the photodetection element and the reference element. Note that “substantially equivalent” as referred to here includes the case where even if the lengths and widths are the same in terms of design, the lengths and widths do not strictly take the design values due to variability in processes such as etching and exposure. According to this configuration, although there is the possibility of slight differences due to self-parasitic storage capacitance, the characteristics of the photodetection element and the reference element are substantially equivalent. As a result, the dark current of the photodetection element and the dark current of the reference element are equivalent, and therefore temperature dependency can be substantially reliably eliminated when the environmental temperature has changed.

Furthermore, the display device according to the first and second configurations can be, but is not limited to being, suitably implemented as a liquid crystal display device further including a common substrate opposing the active matrix substrate, and liquid crystal sandwiched between the active matrix substrate and the common substrate.

Below is a description of more specific embodiments of the present invention with reference to the drawings. Note that although the following embodiments show examples of configurations in which a display device according to the present invention is implemented as a liquid crystal display device, the display device according to the present invention is not limited to a liquid crystal display device, and is applicable to any display device that uses an active matrix substrate. It should also be noted that due to having a photosensor, the display device according to the present invention is envisioned to be used as, for example, a display device with a touch panel that performs input operations after detecting an object that is close to the screen, or a bidirectional communication display device that is equipped with a display function and an image capture function.

Also, for the sake of convenience in the description, the drawings that are referred to below show simplifications of, among the constituent members of the embodiments of the present invention, only relevant members that are necessary for describing the present invention. Accordingly, the display device according to the present invention may include any constituent members that are not shown in the drawings referred to in this specification. Also, regarding the dimensions of the members in the drawings, the dimensions of the actual constituent members, the ratios of the dimensions of the members, and the like are not shown faithfully.

### EMBODIMENT 1

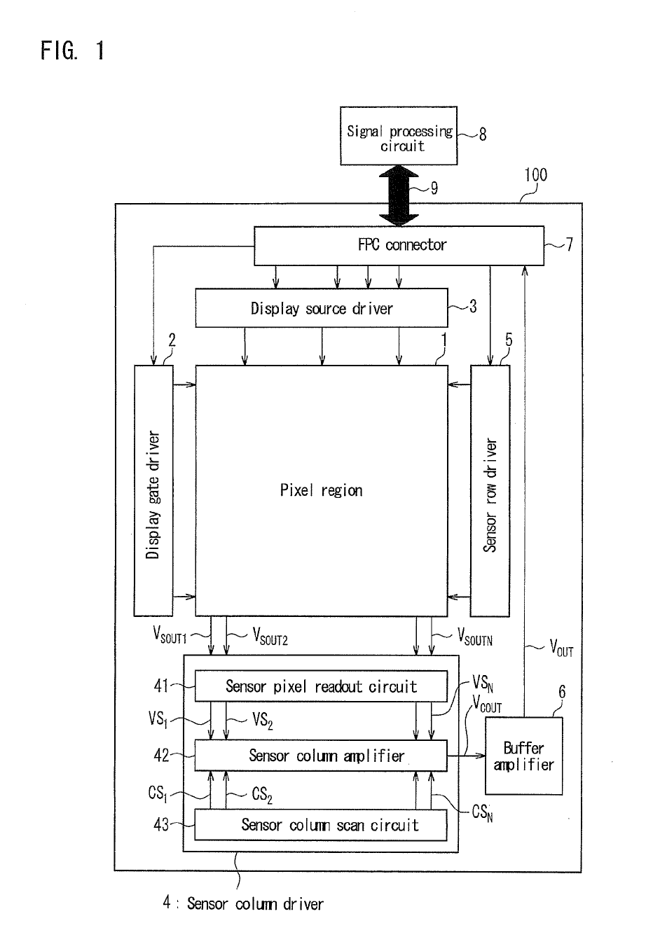

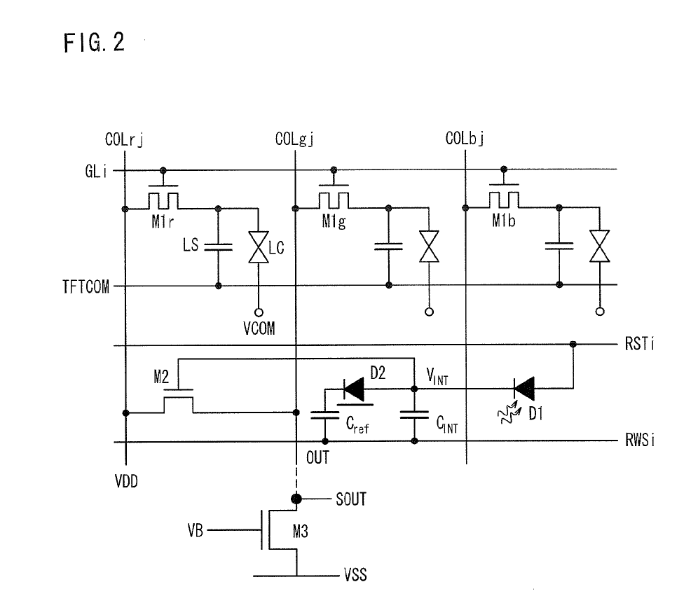

First, a configuration of an active matrix substrate included in a liquid crystal display device according to Embodiment 1 of the present invention will be described with reference to FIGS. 1 and 2.

FIG. 1 is a block diagram showing a schematic configuration of an active matrix substrate 100 included in the liquid crystal display device according to an embodiment of the present invention. As shown in FIG. 1, the active matrix substrate 100 includes at least a pixel region 1, a display gate driver 2, a display source driver 3, a sensor column driver 4, a sensor row driver 5, a buffer amplifier 6, and an FPC connector 7 on a glass substrate. Also, a signal processing circuit 8 for processing image signals picked up by a photodetection element (described later) in the pixel region 1 is connected to the active matrix substrate 100 via the FPC connector 7 and an FPC 9.

Note that the above constituent members on the active matrix substrate 100 can also be formed monolithically on the glass substrate by a semiconductor process. Alternatively, a configuration is possible in which the amplifier and various drivers among the above constituent members are mounted on the glass substrate by COG (Chip On Glass) technology or the like. As another alternative, it is possible for at least some of the above constituent members shown on the active matrix substrate 100 in FIG. 1 to be mounted on the FPC 9. The active matrix substrate 100 is attached to a common substrate (not shown) that has a common electrode formed on the entire face thereof, and a liquid crystal material is enclosed in the gap therebetween.

The pixel region 1 is a region in which a plurality of pixels are formed in order to display an image. In the present embodiment, a photosensor for picking up an image is provided in each pixel in the pixel region 1. FIG. 2 is an equivalent circuit diagram showing the disposition of a pixel and a photosensor in the pixel region 1 of the active matrix substrate 100. In the example in FIG. 2, each pixel is formed by three colors of picture elements, namely R (red), G (green), and B (blue), and one photosensor composed of two photodiodes D1 and D2, a capacitor C_{INT}, and a thin-film transistor M2 is provided in each of the pixels composed of these three picture elements. The pixel region 1 has pixels disposed in a matrix having M rows×N columns, and photosensors that are likewise disposed in a matrix having M rows×N columns. Note that as described above, the number of picture elements is M×3N.

For this reason, as shown in FIG. 2, the pixel region 1 has, as wiring for the pixels, gate lines GL and source lines COL that are disposed in a matrix. The gate lines GL are connected to the display gate driver 2. The source lines COL are connected to the display source driver 3. Note that the gate lines GL are provided in M rows in the pixel region 1. Hereinafter, the notation GLi (i=1 to M) is used when there is a need to distinguish between individual gate lines GL in the description. Meanwhile, three source lines COL are provided in each pixel in order to respectively supply image data to the three picture elements in each pixel as described above. The notations COLrj, COLgj, and COLbj (j=1 to N) are used when there is a need to distinguish between individual source lines COL in the description.

Thin-film transistors (TFTs) M1 are provided as switching elements for the pixels at intersections between the gate lines GL and the source lines COL. Note that in FIG. 2, the thin-film transistors M1 provided in the red, green, and blue picture elements are noted as M1r, M1g, and M1b, respectively. In each thin-film transistor M1, the gate electrode is connected to one of the gate lines GL, the source electrode is connected to one of the source lines COL, and the drain electrode is connected to a pixel electrode, which is not shown. Accordingly, as shown in FIG. 2, a liquid crystal capacitor LC is formed between the drain electrode of each thin-film transistor M1 and the common electrode (VCOM). Also, an auxiliary capacitor LS is formed between each drain electrode and a TFTCOM.

In FIG. 2, the picture element driven by the thin-film transistor M1r, which is connected to the intersection between one gate line GLi and one source line COLrj, is provided with a red color filter so as to correspond to that picture element, and red image data is supplied from the display source driver 3 to that picture element via the source line COLrj, and thus that picture element functions as a red picture element. Also, the picture element driven by the thin-film transistor M1g, which is connected to the intersection between the gate line GLi and the source line COLgj, is provided with a green color filter so as to correspond to that picture element, and green image data is supplied from the display source driver 3 to that picture element via the source line COLgj, and thus that picture element functions as a green picture element. Furthermore, the picture element driven by the thin-film transistor M1b, which is connected to the intersection between the gate line GLi and the source line COLbj, is provided with a blue color filter so as to correspond to that picture element, and blue image data is supplied from the display source driver 3 to that picture element via the source line COLbj, and thus that picture element functions as a blue picture element.

Note that in the example in FIG. 2, the photosensors are provided in the ratio of one per pixel (three picture elements) in the pixel region 1. However, the disposition ratio of the pixels and photosensors is arbitrary and not limited to this example only. For example, one photosensor may be disposed per picture element, and a configuration is possible in which one photosensor is disposed for a plurality of pixels.

As shown in FIG. 2, the photosensor includes the photodiodes D1 and D2, the capacitor C_{INT}, and the thin-film transistor M2. The circuit characteristics and element characteristics of the photodiodes D1 and D2 have been optimized so that the output currents thereof are equivalent when they are not irradiated with light. Since the I-V characteristics (reverse bias region) of the photodiodes are not dependent on the applied voltage, ideally, if the photodiodes D1 and D2 have the same size (length L and width W of the semiconductor layer that functions as the photodetection region), the dark currents thereof are equivalent. Note that, for example, a PN junction diode or PIN junction diode having a lateral structure or stacked structure can be used as the photodiodes D1 and D2. In this case, as described above, it is preferable that two photodiodes whose boundary regions between the p layer and the n layer (i.e., the semiconductor layer that functions as the photodetection region) have the same length and width are used as the photodiodes D1 and D2. According to this preferable configuration, although there is the possibility of fine differences due to self-parasitic capacitance, the output currents of the photodiodes D1 and D2 can be substantially equivalent when they are not irradiated with light. Note that whereas the photodiode D1 receives incident light, the photodiode D2 is used as the reference element that detects a dark current, and therefore is shielded to prevent external light from being incident thereon.

In the example in FIG. 2, the source line COLr also serves as wiring VDD, which is for supplying a constant voltage V_{DD} from the sensor column driver 4 to the photosensor. Also, the source line COLg also serves as wiring OUT for sensor output.

The anode of the photodiode D1 is connected to reset signal wiring RST, which is for supplying a reset signal. The photodiode D1 and the photodiode D2 are connected in series, and the gate of the thin-film transistor M2 and one of the electrodes of the capacitor C_{INT} are connected between the cathode of the photodiode D1 and the anode of the photodiode D2. The cathode of the photodiode D2 is connected to one of the electrodes of a capacitor C_{ref}. The other electrode of the capacitor C_{ref} is connected to the readout signal wiring RWS. The capacitor C_{ref} can be formed by the silicon film forming the cathode of the photodiode D2, the metal film forming the readout signal wiring RWS, and an insulating film therebetween.

The drain of the thin-film transistor M2 is connected to the wiring VDD, and the source is connected to the wiring OUT. The reset signal wiring RST and the readout signal wiring RWS are connected to the sensor row driver 5. Since the reset signal wiring RST and the readout signal wiring RSW are provided in each row, the notations reset signal wiring RSTi and readout signal wiring RWSi (i=1 to M) are used hereinafter when there is a need to distinguish between the pairs of wiring.

The sensor row driver 5 successively selects a reset signal wiring RSTi/readout signal wiring RWSi pair shown in FIG. 2 at a predetermined time interval (t_{row}). Accordingly, each photosensor row in the pixel region 1 from which a signal charge is to be read out is successively selected.

Note that as shown in FIG. 2, the end of the wiring OUT is connected to the drain of a thin-film transistor M3, which is an insulated gate field effect transistor. Also, the drain of this thin-film transistor M3 is connected to output wiring SOUT, and a potential V_{SOUT} of the drain of the thin-film transistor M3 is output to the sensor column driver 4 as an output signal from the photosensor. The source of the thin-film transistor M3 is connected to the wiring VSS. The gate of the thin-film transistor M3 is connected to a reference voltage power supply (not shown) via reference voltage wiring VB.

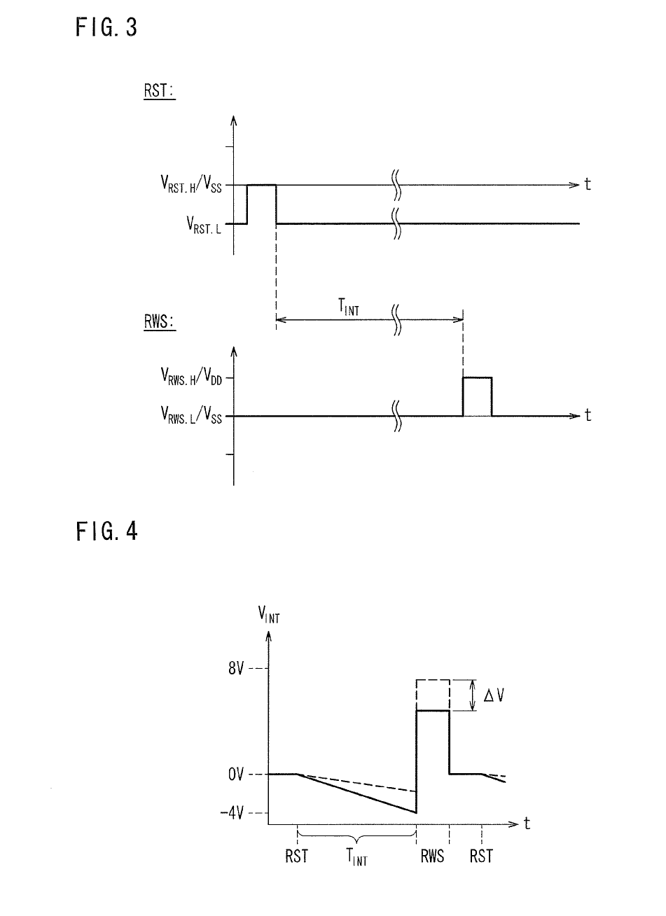

The following describes operations of the photosensor according to the present embodiment with reference to FIGS. 3 and 4. FIG. 3 is a timing chart showing the waveforms of the reset signal supplied from the reset signal wiring RST to the photosensor and the readout signal supplied from the readout signal wiring RWS. FIG. 4 is a waveform diagram showing a relationship between input signals (reset signal and readout signal) and V_{INT} in the photosensor according to Embodiment 1.

In the example shown in FIG. 3, the high level V_{RST.H} of the reset signal is 0 V, and the low level V_{RST.L} thereof is −4 V. In this example, the high level V_{RST.H} of the reset signal is equivalent to V_{SS}. Also, the high level V_{RWS.H} of the readout signal is 8 V, and the low level V_{RWS.L} thereof is 0 V. In this example, the high level V_{RWS.L} of the readout signal is equivalent to V_{DD}, and the low level V_{RWS.L} thereof is equivalent to V_{SS}.

First, when the reset signal supplied from the sensor row driver 5 to the reset signal wiring RST rises from the low level (−4 V) to the high level (0 V), the photodiode D1 becomes forward biased. Since the potential V_{INT} of the gate electrode of the thin-film transistor M2 is lower than the threshold voltage of the thin-film transistor M2 at this time, the thin-film transistor M2 is in a non-conducting state. Note that the capacitor C_{ref} is connected between the cathode of the photodiode D2 and the readout signal wiring RWS. Accordingly, the photodiode D2 is also reset by the reset signal.

Next, the reset signal returns to the low level V_{RST.L}, and thus the photocurrent integration period (period T_{INT} shown in FIG. 4) begins In the integration period, the photodiodes D1 and D2 become reverse-biased, current flows out of the capacitor C_{INT} and the capacitor C_{ref} to discharge the capacitor C_{INT} and the capacitor C_{ref}. At this time, the current from the photodiode D1 that flows from the storage node INT is the sum of the photocurrent I_{PHOTO} generated by incident light and the dark current I_{DARK}. On the other hand, the current from the photodiode D2 that flows out of the storage node INT is the dark current −I_{DARK}. As a result, the current that flows from the capacitor C_{INT} to the storage node INT is substantially only the photocurrent I_{PHOTO} component. In the integration period as well, V_{INT} is lower than the threshold voltage of the thin-film transistor M2, and therefore the thin-film transistor M2 is in the non-conducting state.

When the integration period ends, the readout signal rises as shown in FIG. 3, and thus the readout period begins. At this point, the injection of charge into the capacitor C_{INT} occurs. As a result, the potential V_{INT} of the gate electrode of the thin-film transistor M2 rises higher than the threshold voltage of the thin-film transistor M2. Accordingly, the thin-film transistor M2 enters the conducting state and functions as a source follower amplifier along with the bias thin-film transistor M3 provided at the end of the wiring OUT in each column. In other words, the output signal voltage from the output wiring SOUT from the drain of the thin-film transistor M3 corresponds to the integral value of the photocurrent I_{PHOTO} generated due to light that has been incident on the photodiode D1 in the integration period.

Note that in FIG. 4, the broken line waveform indicates changes in the potential V_{INT} in the case where a small amount of light is incident on the photodiode D1, and the solid line waveform indicates changes in the potential V_{INT} in the case where external light has been incident on the photodiode D1. In FIG. 4, ΔV is a potential difference proportionate to the integral value of the photocurrent I_{PHOTO} from the photodiode D1.

As described above, periodically performing initialization with a reset pulse, integration of the photocurrent in the integration period, and reading out of sensor output in the readout period enables obtaining photosensor output for each pixel.

As described above, in the photosensor provided in each pixel of the display device according to the present embodiment, the capacitor C_{INT} is charged with and discharges only the photocurrent I_{PHOTO} component of the photodiode D1, thus enabling accurately measuring the intensity of external light regardless of the magnitude of the dark current I_{DARK}. Also, a wide dynamic range can be obtained since the dark current I_{DARK} is not discharged from the capacitor C_{INT}. Accordingly, it is possible to realize a photosensor that can highly accurately measure the intensity of external light without being influenced by the environmental temperature.

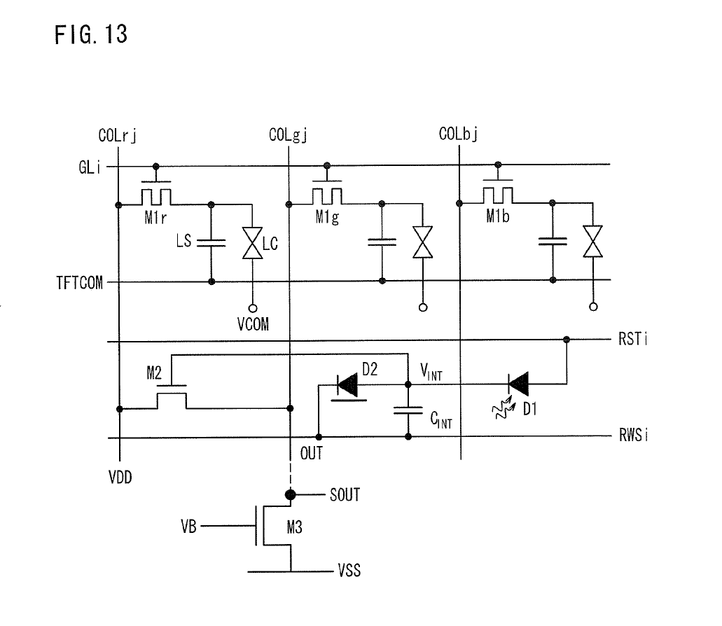

Note that although a photosensor including the capacitor C_{ref} is disclosed in the present embodiment, a configuration is possible in which, as shown in FIG. 13, the capacitor C_{ref} is omitted, and the cathode of the photodiode D2 is connected to the readout signal wiring RWS. According to this configuration as well, the capacitor C_{INT} is charged with and discharges only the photocurrent I_{PHOTO} component of the photodiode D1, thus enabling accurately measuring the intensity of external light regardless of the magnitude of the dark current I_{DARK}. Also, a wide dynamic range can be obtained since the dark current I_{DARK} is not discharged from the capacitor C_{INT}. Accordingly, it is possible to realize a photosensor that can highly accurately measure the intensity of external light without being influenced by the environmental temperature.

However, the configuration shown in FIG. 2 (i.e., the configuration including the capacitor C_{ref}) has the following advantages over the configuration shown in FIG. 13 (i.e., the configuration in which capacitor C_{ref} has been omitted). In the case of the configuration in FIG. 13, the value of V_{RWS.L} applied to the photodiode D2 in the integration period needs to be set such that a reverse bias is applied to the photodiode D2. In other words, it is necessary for V_{RWS.L} to be higher than the potential V_{INT} of the storage node INT In the case where V_{RWS.L} is lower than the potential V_{INT} of the storage node INT, even if the reset signal (V_{RST.H}) is applied via the reset signal wiring RST for resetting, a forward bias is applied to the photodiode D2, and therefore the storage node INT cannot be properly reset. However, in the configuration in FIG. 2, the capacitor C_{ref} is provided between the cathode of the photodiode D2 and the readout signal wiring RWS, thus enabling the storage node INT to be properly reset regardless of the value of V_{RWS.L}. The configuration in FIG. 2 therefore has the advantage that the value of V_{RWS.L} can be set freely.

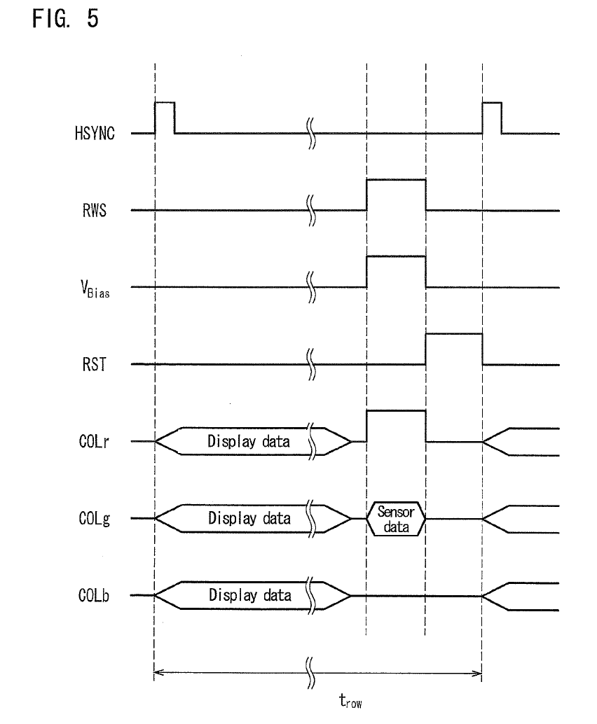

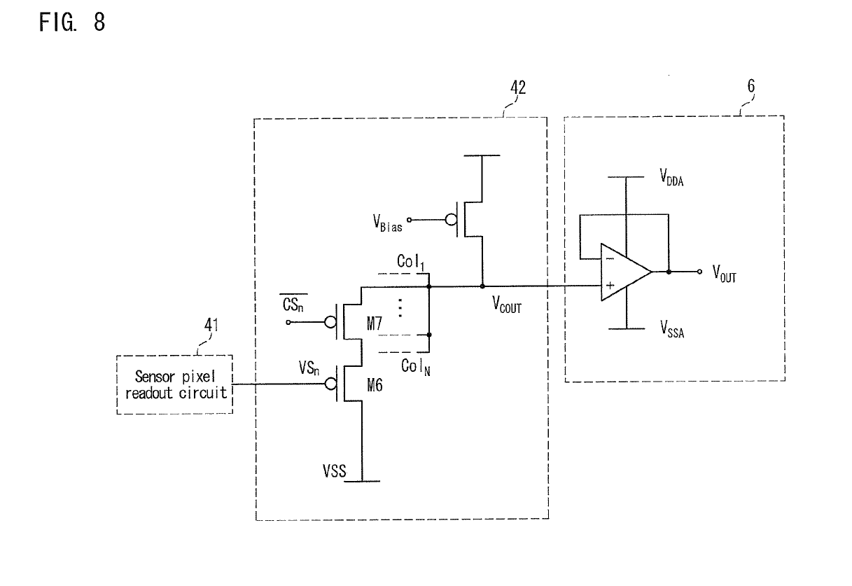

Note that in the present embodiment, as previously described, the source lines COLr and COLg are also used as the photosensor wiring VDD and the wiring OUT, and therefore as shown in FIG. 5, it is necessary to distinguish between times when image data signals for display are input via the source lines COLr, COLg, and COLb, and times when sensor output is read out. In the example in FIG. 5, after the input of the image data signal for display in a horizontal scan period has ended, the reading out of the sensor output is performed using a horizontal blanking period or the like. In other words, after the input of the display image data signal has ended, the constant voltage V_{DD} is applied to the source line COLr. Note that HSYNC in FIG. 8 indicates a horizontal synchronization signal.

As shown in FIG. 1, the sensor column driver 4 includes a sensor pixel readout circuit 41, a sensor column amplifier 42, and a sensor column scan circuit 43. The sensor pixel readout circuit 41 is connected to the output wiring SOUT (see FIG. 2) that outputs the sensor output V_{SOUT} from the pixel region 1. In FIG. 1, the sensor output that is output by output wiring SOUTj (j=1 to N) is designated by V_{SOUTj}. The sensor pixel readout circuit 41 outputs peak hold voltages V_{Sj} of the sensor output V_{SOUTj} to the sensor column amplifier 42. The sensor column amplifier 42 includes N column amplifiers that correspond to the photosensors in the N columns in the pixel region 1, and the column amplifiers amplify the corresponding peak hold voltages V_{Sj} (j=1 to N), and output the resulting peak hold voltages to the buffer amplifier 6 as V_{COUT}. The sensor column scan circuit 43 outputs column select signals CSⱼ (j=1 to N) to the sensor column amplifier 42 in order to successively connect the column amplifiers of the sensor column amplifier 42 to the output bound for the buffer amplifier 6.

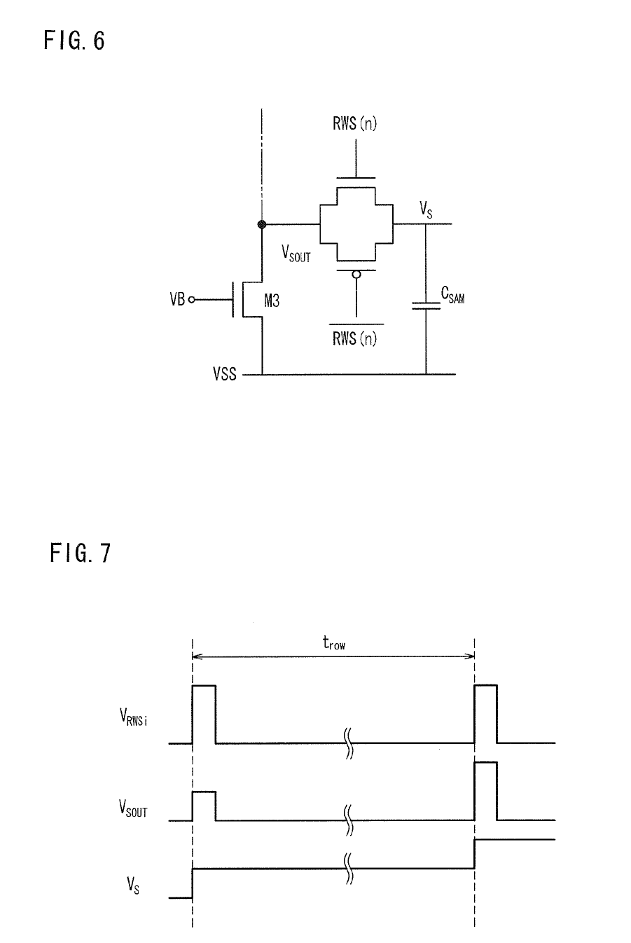

The following describes operations of the sensor column driver 4 and the buffer amplifier 6 that are performed after the sensor output V_{SOUT} has been read out from the pixel region 1, with reference to FIGS. 6 and 7. FIG. 6 is a circuit diagram showing an internal configuration of the sensor pixel readout circuit 41. FIG. 7 is a waveform diagram showing a relationship between the readout signal, sensor output, and output of the sensor pixel readout circuit. As previously described, when the readout signal has risen to the high level V_{RWS.H}, the thin-film transistor M2 becomes conductive, and therefore a source follower amplifier is formed by the thin-film transistors M2 and M3, and the sensor output V_{SOUT} is stored in a sample capacitor C_{SAM} of the sensor pixel readout circuit 41. Accordingly, even after the readout signal has fallen to the low level V_{RWS.L}, in the selection period of that row (t_{row}), the output voltage V_{S} from the sensor pixel readout circuit 41 to the sensor column amplifier 42 is kept at the same level as the peak value of the sensor output V_{SOUT}, as shown in FIG. 7.

Next is a description of operations of the sensor column amplifier 42 with reference to FIG. 8. As shown in FIG. 8, the output voltages V_{Sj} (j=1 to N) of the columns are input from the sensor pixel readout circuit 41 to the N column amplifiers of the sensor column amplifier 42. As shown in FIG. 8, each column amplifier is composed of thin-film transistors M6 and M7. The column select signals C_{Sj} generated by the sensor column scan circuit 43 successively become on for each of the N columns in the select period of one row (t_{row}), and therefore the thin-film transistor M6 of any one of the N column amplifiers in the sensor column amplifier 42 is switched on, and any one of the output voltages V_{Sj} (j=1 to N) of the columns is output as the output V_{COUT} from the sensor column amplifier 42 via that thin-film transistor M6. The buffer amplifier 6 then amplifies the V_{COUT} that has been output from the sensor column amplifier 42, and outputs the resulting amplified V_{COUT} to the signal processing circuit 8 as panel output (a photosensor signal) Vₒᵤₜ.

Note that although the sensor column scan circuit 43 may scan the photosensor columns one column at a time as described above, there is no limitation to this, and a configuration is possible in which the photosensor columns are interlace-scanned. Also, the sensor column scan circuit 43 may be formed as a multi-phase drive scan circuit that has, for example, four phases.

According to the above configuration, the display device according to the present embodiment obtains panel output V_{OUT} that is in accordance with the amount of light received by the photodiode D1 formed in each pixel in the pixel region 1. The panel output V_{OUT} is sent to the signal processing circuit 8, subjected to A/D conversion, and then stored in a memory (not shown) as panel output data. Specifically, the same number of panel output data pieces as the number of pixels (number of photosensors) in the pixel region 1 are stored in this memory. With use of the panel output data stored in the memory, the signal processing circuit 8 performs various types of signal processing such as image pickup and the detection of a touch area. Note that although the same number of panel output data pieces as the number of pixels (number of photosensors) in the pixel region 1 are stored in the memory of the signal processing circuit 8 in the present embodiment, due to constraints such as memory capacity, there is no need to necessarily store the same number of panel output data pieces as the number of pixels.

### EMBODIMENT 2

Below is a description of a display device according to Embodiment 2 of the present invention. Note that the same reference numerals are used for constituent elements that have functions similar to those of the constituent elements described in Embodiment 1, and detailed descriptions thereof will be omitted.

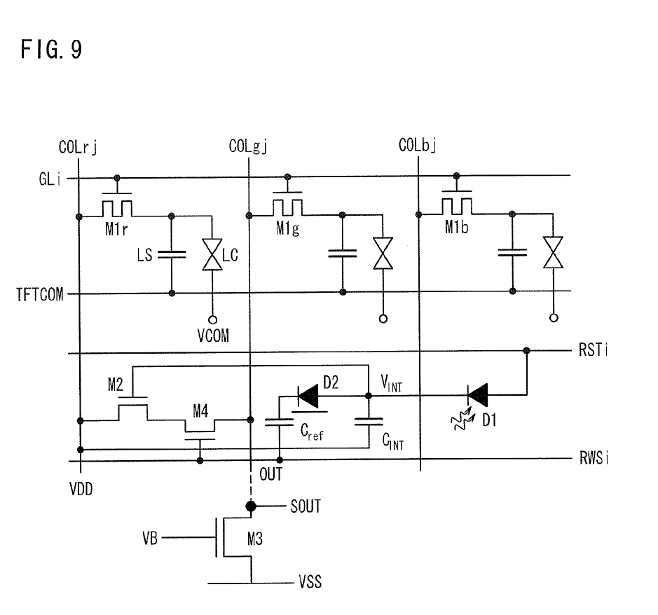

FIG. 9 is an equivalent circuit diagram showing a configuration of a pixel in the display device according to Embodiment 2. As shown in FIG. 9, a photosensor of the display device according to Embodiment 2 includes a thin-film transistor M4 in addition to the photodiodes D1 and D2, the capacitor C_{INT}, and the thin-film transistor M2.

In the photosensor of the present embodiment, one of the electrodes of the capacitor C_{INT} is connected to the gate electrode of the thin-film transistor M2 between the cathode of the photodiode D1 and the anode of the photodiode D2, and the other electrode of the capacitor C_{INT} is connected to the wiring VDD. Also, the drain of the thin-film transistor M2 is connected to the wiring VDD, and the source is connected to the drain of the thin-film transistor M4. The gate of the thin-film transistor M4 is connected to the readout signal wiring RWS. The source of the thin-film transistor M4 is connected to the wiring OUT. Note that although a configuration in which one of the electrodes of the capacitor C_{INT} and the drain of the thin-film transistor M4 are both connected in common to constant voltage wiring (wiring VDD) is shown in this example, a configuration is possible in which they are connected to mutually different constant voltage wiring.

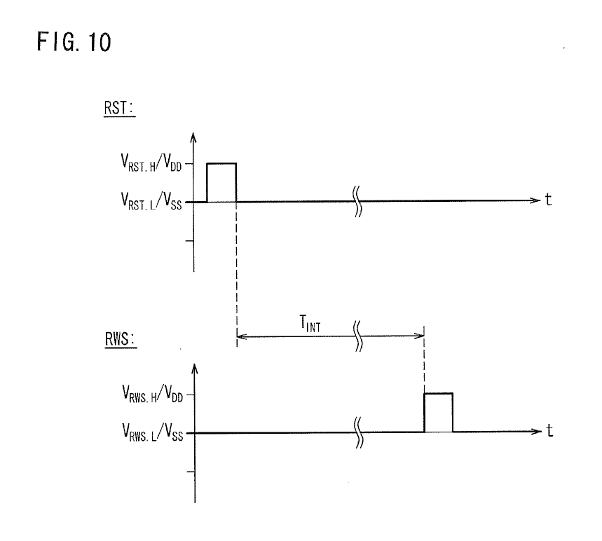

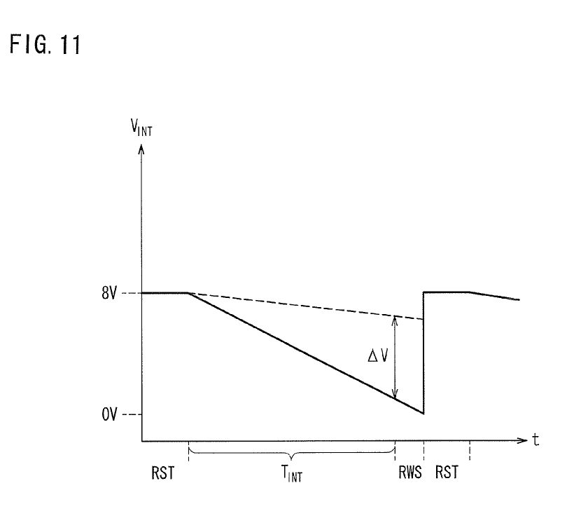

The following describes operations of the photosensor according to the present embodiment with reference to FIGS. 10 and 11.

FIG. 10 is a timing chart showing the waveforms of the reset signal supplied from the reset signal wiring RST to the photosensor and the readout signal supplied from the readout signal wiring RWS. FIG. 11 is a waveform diagram showing a relationship between input signals (reset signal and readout signal) and V_{INT} in the photosensor according to Embodiment 2.

The high level V_{RST.H} of the reset signal is set to a potential at which the thin-film transistor M2 enters the on state. In the example shown in FIG. 10, the high level V_{RST.H} of the reset signal is 8 V. Also, the low level V_{RST.L} of the reset signal is 0 V. In this example, the high level V_{RST.H} of the reset signal is equivalent to V_{DD}, and the low level V_{RST.L} thereof is equivalent to V_{SS}. Also, the high level V_{RWS.H} of the readout signal is 8 V, and the low level V_{RWS.L} thereof is 0 V. In this example, the high level V_{RWS.H} of the readout signal is equivalent to V_{DD}, and the low level V_{RWS.L} thereof is equivalent to V_{SS}.

First, when the reset signal supplied from the sensor row driver 5 to the reset signal wiring RST rises from the low level (0 V) to the high level (8 V), the photodiode D1 becomes forward biased. At this time, although the thin-film transistor M2 enters the on state, there is no output to the wiring OUT since the readout signal is at the low level and the thin-film transistor M4 is in the off state.

Next, the reset signal returns to the low level V_{RST.L}, and thus the photocurrent integration period (period T_{INT} shown in FIG. 11) begins. In the integration period, the photodiodes D1 and D2 become reverse-biased, current flows out of the capacitor C_{INT} and the capacitor C_{ref} to discharge the capacitor C_{INT} and the capacitor C_{ref}. At this time, the current from the photodiode D1 that flows from the storage node INT is the sum of the photocurrent I_{PHOTO} generated by incident light and the dark current I_{DARK}. On the other hand, the current from the photodiode D2 that flows out of the storage node INT is the dark current −I_{DARK}. As a result, the current that flows from the capacitor C_{INT} to the storage node INT is substantially only the photocurrent I_{PHOTO}component. In the integration period as well, V_{INT} drops from the reset potential (in this example, V_{RST.H}=8 V) in accordance with the intensity of incident light. However, there is no sensor output to the wiring OUT since the thin-film transistor M4 is in the off state. Note that the sensor circuit is desirably designed such that the sensor output is the lowest in the case where the photodiode D1 has been irradiated with light whose brightness is the maximum value that is to be measured, that is to say, such that the potential (V_{INT} of the gate electrode of the thin-film transistor M2 takes a value that slightly exceeds the threshold in this case. According to such a design, if the photodiode D1 has been irradiated with light whose brightness exceeds the maximum value to be measured, the value of V_{INT} falls below the threshold of the thin-film transistor M2 and the thin-film transistor M2 enters the off state, and thus there is no sensor output to the wiring OUT.

When the integration period ends, the readout signal rises as shown in FIG. 11, and thus the readout period begins. Due to the readout signal rising to the high level, the thin-film transistor M4 enters the on state. Accordingly, output from the thin-film transistor M2 is output through the thin-film transistor M4 to the wiring OUT. At this time, the thin-film transistor M2 functions as a source follower amplifier along with the bias thin-film transistor M3 provided at the end of the wiring OUT in each column. In other words, the output signal voltage from the output wiring SOUT corresponds to the integral value of the photocurrent I_{PHOTO} generated due to light that has been incident on the photodiode D1 in the integration period.

Note that in FIG. 11, the broken line waveform indicates changes in the potential V_{INT} in the case where a small amount of light is incident on the photodiode D1, and the solid line waveform indicates changes in the potential V_{INT} in the case where external light has been incident on the photodiode D1. In FIG. 11, ΔV is a potential difference proportionate to the integral value of the photocurrent I_{PHOTO} from the photodiode D1.

As described above, according to the photosensor of the present embodiment as well, periodically performing initialization with a reset pulse, integration of the photocurrent in the integration period, and reading out of sensor output in the readout period enables obtaining photosensor output for each pixel.

In other words, in the photosensor provided in each pixel of the display device according to the present embodiment as well, the capacitor C_{INT} discharges only the photocurrent I_{PHOTO} component of the photodiode D1 similarly to Embodiment 1, thus enabling accurately measuring the intensity of external light regardless of the magnitude of the dark current I_{DARK}. Also, a wide dynamic range can be obtained since the dark current I_{DARK} is not discharged from the capacitor C_{INT}. Accordingly, it is possible to realize a photosensor that can highly accurately measure the intensity of external light without being influenced by the environmental temperature.

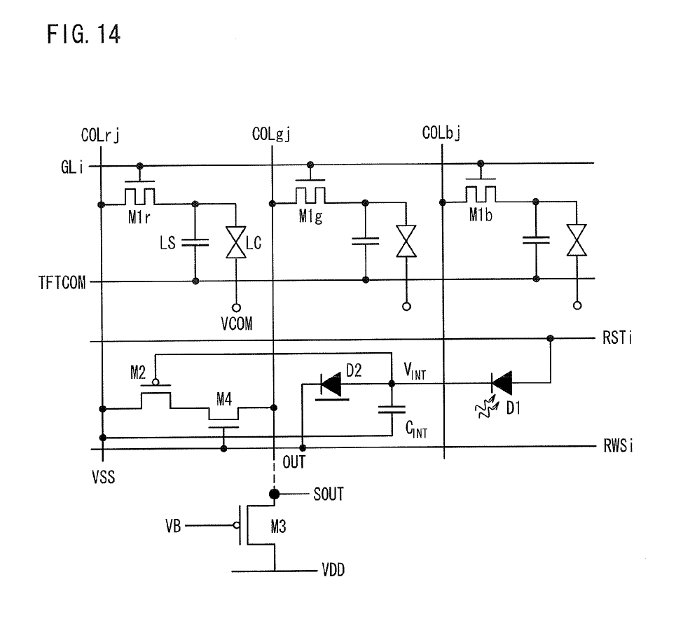

In the present embodiment as well, a configuration is possible in which, as shown in FIG. 14, the capacitor C_{ref} is omitted, and the cathode of the photodiode D2 is directly connected to the readout signal wiring RWS. Note that in the configuration shown in FIG. 14, in order to prevent a forward bias from being applied to the photodiode D2 in the storage period, it is necessary to change the voltage of the reset signal through a configuration in which p channel TFTs are used as the thin-film transistors M2 and M3, the drain of the thin-film transistor M2 is connected to VSS, and the source of the thin-film transistor M3 is connected to VDD. Note that the drive waveforms of the reset signal and the readout signal are the same as the waveforms shown in FIG. 3 in Embodiment 1. It should also be noted that as described in Embodiment 1, the configuration shown in FIG. 9 (i.e., the configuration including the capacitor C_{ref}) has an advantage over the configuration shown in FIG. 14 (i.e., the configuration in which the capacitor C_{ref} has been omitted) in that the value of V_{RWS.L}, can be set freely since the storage node INT can be reset properly regardless of the value of V_{RWS.L}.

### EMBODIMENT 3

Below is a description of a display device according to Embodiment 3 of the present invention. Note that the same reference numerals are used for constituent elements that have functions similar to those of the constituent elements described in Embodiments 1 and 2 above, and detailed descriptions thereof will be omitted.

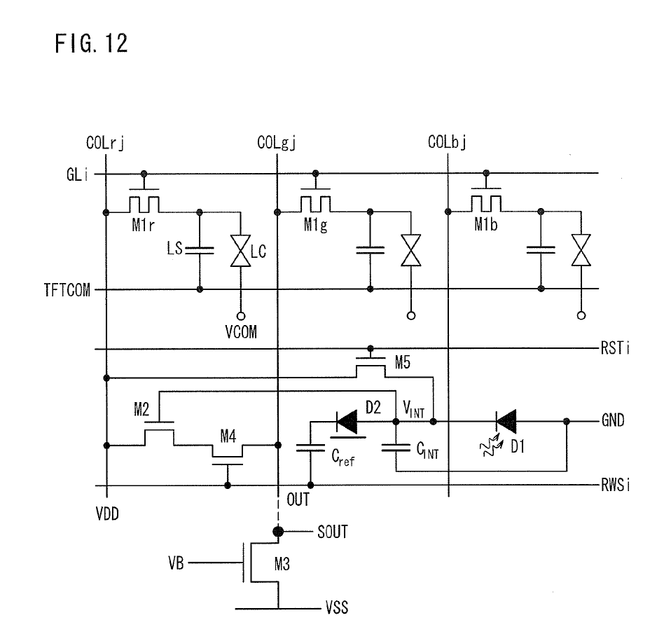

FIG. 12 is an equivalent circuit diagram showing a configuration of a pixel in the display device according to Embodiment 3. As shown in FIG. 12, a photosensor of the display device according to Embodiment 3 includes a thin-film transistor M5 in addition to the photodiodes D1 and D2, the capacitor C_{INT}, and the thin-film transistors M2 and M4.

In the photosensor of the present embodiment, one of the electrodes of the capacitor C_{INT} is connected between the cathode of the photodiode D1 and the anode of the photodiode D2, and the other electrode of the capacitor C_{INT} is connected to GND. Also, the gate of the thin-film transistor M2 is connected between the cathode of the photodiode D1 and the anode of the photodiode D2. The drain of the thin-film transistor M2 is connected to the wiring VDD, and the source thereof is connected to the drain of the thin-film transistor M4. The gate of the thin-film transistor M4 is connected to the readout signal wiring RWS. The source of the thin-film transistor M4 is connected to the wiring OUT The gate of the thin-film transistor M5 is connected to the reset signal wiring RST, the drain thereof is connected to the wiring VDD, and the source thereof is connected between the cathode of the photodiode D1 and the anode of the photodiode D2. Note that although a configuration in which the drains of the thin-film transistors M4 and M5 are both connected in common to constant voltage wiring (wiring VDD) is shown in this example, a configuration is possible in which each of them is connected to different constant voltage wiring.

The following describes operations of the photosensor according to the present embodiment. Note that the waveforms of the reset signal supplied from the reset signal wiring RST to the photosensor of the present embodiment and the readout signal supplied from the readout signal wiring RWS are the same as in FIG. 10 referenced in Embodiment 3. Also, the waveform diagram showing a relationship between input signals (reset signal and readout signal) and V_{INT} in the photosensor according to the present embodiment is the same as in FIG. 11 referenced in Embodiment 2. Therefore, the following description of the present embodiment will also be made with reference to FIGS. 10 and 11.

The high level V_{RST.H} of the reset signal is set to a potential at which the thin-film transistor M5 enters the on state. In the example shown in FIG. 10, the high level V_{RWS.H} of the reset signal is 8 V. Also, the low level V_{RST.L} of the reset signal is 0 V. In this example, the high level V_{RST.H} of the reset signal is equivalent to V_{DD}, and the low level V_{RST.L} thereof is equivalent to V_{SS}. Also, the high level V_{RWS.H} of the readout signal is 8 V, and the low level V_{RWS.L} thereof is 0 V. In this example, the high level V_{RWS.H} of the readout signal is equivalent to V_{DD}, and the low level V_{RWS.L} thereof is equivalent to V_{SS}.

First, when the reset signal supplied from the sensor row driver 5 to the reset signal wiring RST rises from the low level (V_{RST.L}=0 V) to the high level (V_{RST.H}=8 V), the thin-film transistor M5 enters the on state. Accordingly, the potential V_{INT} at the connection point between the cathode of the photodiode D1 and the anode of the photodiode D2 is reset to VDD.

Next, the reset signal returns to the low level V_{RST.L}, and thus the photocurrent integration period (period T_{INT} shown in FIG. 11) begins. At this time, due to the reset signal switching to the low level, the thin-film transistor M5 enters the off state. At this point, the anode of the photodiode D1 is at GND, and the cathode thereof is at (V_{INT}=V_{DD}=8 V), and therefore a reverse bias is applied to the photodiode D1. In the integration period, the photodiodes D1 and D2 become reverse-biased, current flows out of the capacitor C_{INT} and the capacitor C_{ref} to discharge the capacitor C_{INT} and the capacitor C_{ref}. At this time, the current from the photodiode D1 that flows from the storage node INT is the sum of the photocurrent I_{PHOTO}generated by incident light and the dark current I_{DARK}. On the other hand, the current from the photodiode D2 that flows out of the storage node INT is the dark current −I_{DARK}. As a result, the current that flows from the capacitor C_{INT} to the storage node INT is substantially only the photocurrent I_{PHOTO} component. In the integration period, V_{INT} drops from the reset potential (in this example, V_{RST.H}=8 V) in accordance with the intensity of incident light. However, there is no sensor output to the wiring OUT since the thin-film transistor M4 is in the off state. Note that the sensor circuit is desirably designed such that the sensor output is the lowest in the case where the photodiode D1 has been irradiated with light whose brightness is the maximum value that is to be measured, that is to say, such that the potential (V_{INT}) of the gate electrode of the thin-film transistor M2 takes a value that slightly exceeds the threshold in this case. According to such a design, if the photodiode D1 has been irradiated with light whose brightness exceeds the maximum value to be measured, the value of V_{INT} falls below the threshold of the thin-film transistor M2 and the thin-film transistor M2 enters the off state, and thus there is no sensor output to the wiring OUT.

When the integration period ends, the readout signal rises as shown in FIG. 11, and thus the readout period begins. Due to the readout signal rising to the high level, the thin-film transistor M4 enters the on state. Accordingly, output from the thin-film transistor M2 is output through the thin-film transistor M4 to the wiring OUT. At this time, the thin-film transistor M2 functions as a source follower amplifier along with the bias thin-film transistor M3 provided at the end of the wiring OUT in each column. In other words, the output signal voltage from the output wiring SOUT corresponds to the integral value of the photocurrent I_{PHOTO} generated due to light that has been incident on the photodiode D1 in the integration period.

As described above, according to the photosensor of the present embodiment as well, periodically performing initialization with a reset pulse, integration of the photocurrent in the integration period, and reading out of sensor output in the readout period enables obtaining photosensor output for each pixel.

In other words, in the photosensor provided in each pixel of the display device according to the present embodiment as well, the capacitor C_{INT} discharges only the photocurrent I_{PHOTO} component of the photodiode D1 similarly to Embodiments 1 and 2, thus enabling accurately measuring the intensity of external light regardless of the magnitude of the dark current I_{DARK}. Also, a wide dynamic range can be obtained since the dark current I_{DARK} is not discharged from the capacitor C_{INT}. Accordingly, it is possible to realize a photosensor that can highly accurately measure the intensity of external light without being influenced by the environmental temperature.

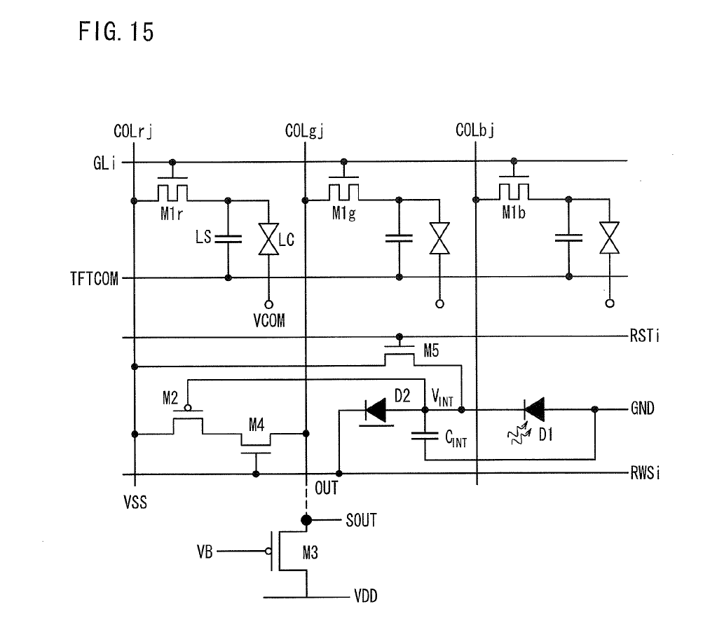

In the present embodiment as well, a configuration is possible in which, as shown in FIG. 15, the capacitor C_{ref} is omitted, and the cathode of the photodiode D2 is directly connected to the readout signal wiring RWS. Note that in the configuration shown in FIG. 15, in order to prevent a forward bias from being applied to the photodiode D2 in the storage period, it is necessary to change the voltage of the reset signal through a configuration in which p channel TFTs are used as the thin-film transistors M2 and M3, the drain of the thin-film transistor M2 is connected to VSS, the source of the thin-film transistor M3 is connected to VDD, and furthermore the anode of the photodiode D1 is connected to VSSR instead of GND. Note that the drive waveforms of the reset signal and the readout signal are the same as the waveforms shown in FIG. 3 in Embodiment 1. It should also be noted that as described in Embodiment 1, the configuration shown in FIG. 12 (i.e., the configuration including the capacitor C_{ref}) has an advantage over the configuration shown in FIG. 15 (i.e., the configuration in which the capacitor C_{ref} has been omitted) in that the value of V_{RWS.L}, can be set freely since the storage node INT can be reset properly regardless of the value of V_{RWS.L}.

Although the present invention has been described based on Embodiments 1 to 3, the present invention is not limited to the above-described embodiments only, and it is possible to make various changes within the scope of the invention.

For example, Embodiments 1 to 3 describe an example of a configuration in which the wiring VDD and the wiring OUT that the photosensor is connected to are also used as the source wiring COL. This configuration has the advantage that the pixel aperture ratio is high. However, even with a configuration in which the photosensor wiring VDD and the wiring OUT are provided separately from the source wiring COL, it is possible to achieve effects similar to those in the above-described Embodiments 1 and 2. In particular, in Embodiment 2, with a configuration in which the photosensor wiring VDD and the source wiring COL are provided separately, and the thin-film transistor M2 and the capacitor C_{INT} are connected to this wiring VDD, there is the advantage of preventing the potential of the capacitor C_{INT} from becoming unstable due to the influence of a video signal input to the source wiring COL.

Note that as an alternative to the above description, a configuration is possible in which transistors M3, M6, and M7 provided in an IC chip, for example, are used instead of the thin-film transistors M3, M6, and M7 formed on the active matrix substrate.

### INDUSTRIAL APPLICABILITY

The present invention is industrially applicable as a display device having a photosensor in a pixel region of an active matrix substrate.

### EXPLANATION OF REFERENCES

1 pixel region

2 display gate driver

3 display source driver

4 sensor column driver

41 sensor pixel readout circuit

42 sensor column amplifier

43 sensor column scan circuit

5 sensor row driver

6 buffer amplifier

7 FPC connector

8 signal processing circuit

9 FPC

100 active matrix substrate

1. A display device comprising a photosensor in a pixel region of an active matrix substrate,
the photosensor comprising:
a photodetection element that receives incident light;
a reference element connected in series to the photodetection element and having a light shielding layer that blocks incident light;
a storage capacitor, one electrode of which is connected to a connection point between the photodetection element and the reference element, that is charged with and discharges output current from the photodetection element and the reference element;
reset signal wiring that supplies a reset signal to the photosensor;
readout signal wiring that supplies a readout signal to the photosensor;
a switching element having a control electrode connected to a connection point between the photodetection element and the reference element; and
a capacitor connected between the readout signal wiring and an electrode of the reference element that is not connected to the photodetection element,
wherein from when the reset signal is supplied until when the readout signal is supplied, the photosensor charges the storage capacitor or outputs sensor output that is in accordance with the output current discharged from the storage capacitor.

2. A display device comprising a photosensor in a pixel region of an active matrix substrate,
the photosensor comprising:
a photodetection element that receives incident light;
a reference element connected in series to the photodetection element and having a light shielding layer that blocks incident light;
a storage capacitor, one electrode of which is connected to a connection point between the photodetection element and the reference element, that is charged with and discharges output current from the photodetection element and the reference element;
reset signal wiring that supplies a reset signal to the photosensor;
readout signal wiring that supplies a readout signal to the photosensor; and
a switching element having a control electrode connected to a connection point between the photodetection element and the reference element,
wherein an electrode of the reference element that is not connected to the photodetection element is connected to the readout signal wiring, and
from when the reset signal is supplied until when the readout signal is supplied, the photosensor charges the storage capacitor or outputs sensor output that is in accordance with the output current discharged from the storage capacitor.

3. The display device according to claim 1,
wherein the switching element includes one transistor, and
the readout signal wiring is connected to another electrode of the storage capacitor.

4. The display device according to claim 1,
wherein the switching element includes a first transistor and a second transistor,
a control electrode of the first transistor is connected to a connection point between the photodetection element and the reference element,
one of two electrodes other than the control electrode of the first transistor is connected to wiring that supplies a power supply voltage,
the other of the two electrodes other than the control electrode of the first transistor is connected to one of two electrodes other than a control electrode of the second transistor,
the readout signal wiring is connected to the control electrode of the second transistor,
one electrode of the storage capacitor is connected to the wiring that supplies the power supply voltage, and
the other of the two electrodes other than the control electrode of the second transistor is connected to wiring for reading out the output current.

5. The display device according to claim 1,
wherein the switching element includes a first transistor, a second transistor, and a third transistor,
a control electrode of the first transistor is connected to a connection point between the photodetection element and the reference element,
one of two electrodes other than the control electrode of the first transistor is connected to wiring that supplies a power supply voltage,
the other of the two electrodes other than the control electrode of the first transistor is connected to one of two electrodes other than a control electrode of the second transistor,
the storage capacitor is connected in parallel to the photodetection element,
the readout signal wiring is connected to the control electrode of the second transistor,
the other of the two electrodes other than the control electrode of the second transistor is connected to wiring for reading out the output current,
a control electrode of the third transistor is connected to the reset signal wiring,
one of two electrodes other than the control electrode of the third transistor is connected to a connection point between the photodetection element and the reference element, and
the other of the two electrodes other than the control electrode of the third transistor is connected to the wiring that supplies the power supply voltage.

6. The display device according to claim 1, wherein in a case where no light is incident on the photosensor, an output current from the photodetection element and an output current from the reference element are equivalent.

7. The display device according to claim 1,
wherein the photodetection element and the reference element are each a photodiode, and
the length and width of a gap between a p layer and an n layer are substantially equivalent between the photodetection element and the reference element.

8. The display device according to claim 1, further comprising:
a common substrate opposing the active matrix substrate; and
liquid crystal sandwiched between the active matrix substrate and the common substrate.

9. The display device according to claim 2,
wherein the switching element includes one transistor, and
the readout signal wiring is connected to another electrode of the storage capacitor.

10. The display device according to claim 2,
wherein the switching element includes a first transistor and a second transistor,
a control electrode of the first transistor is connected to a connection point between the photodetection element and the reference element,
one of two electrodes other than the control electrode of the first transistor is connected to wiring that supplies a power supply voltage,
the other of the two electrodes other than the control electrode of the first transistor is connected to one of two electrodes other than a control electrode of the second transistor,
the readout signal wiring is connected to the control electrode of the second transistor,
one electrode of the storage capacitor is connected to the wiring that supplies the power supply voltage, and
the other of the two electrodes other than the control electrode of the second transistor is connected to wiring for reading out the output current.

11. The display device according to claim 2,
wherein the switching element includes a first transistor, a second transistor, and a third transistor,
a control electrode of the first transistor is connected to a connection point between the photodetection element and the reference element,
one of two electrodes other than the control electrode of the first transistor is connected to wiring that supplies a power supply voltage,
the other of the two electrodes other than the control electrode of the first transistor is connected to one of two electrodes other than a control electrode of the second transistor,
the storage capacitor is connected in parallel to the photodetection element,
the readout signal wiring is connected to the control electrode of the second transistor,
the other of the two electrodes other than the control electrode of the second transistor is connected to wiring for reading out the output current,
a control electrode of the third transistor is connected to the reset signal wiring,
one of two electrodes other than the control electrode of the third transistor is connected to a connection point between the photodetection element and the reference element, and
the other of the two electrodes other than the control electrode of the third transistor is connected to the wiring that supplies the power supply voltage.

12. The display device according to claim 2, wherein in a case where no light is incident on the photosensor, an output current from the photodetection element and an output current from the reference element are equivalent.

13. The display device according to claim 2,
wherein the photodetection element and the reference element are each a photodiode, and
the length and width of a gap between a p layer and an n layer are substantially equivalent between the photodetection element and the reference element.

14. The display device according to claim 2, further comprising:
a common substrate opposing the active matrix substrate; and
liquid crystal sandwiched between the active matrix substrate and the common substrate.
